(19) United States
(12) Patent Application Publication
(10) Pub. No.: US 2015/0083939 A1
(43) Pub. Date: Mar. 26, 2015

(54) EXTREME ULTRAVIOLET LIGHT GENERATION DEVICE AND EXTREME ULTRAVIOLET LIGHT GENERATION SYSTEM

(71) Applicant: GIGAPHOTON INC., Tochigi (JP)

(72) Inventors: Yoshifumi UENO, Tochigi (JP); Osamu WAKABAYASHI, Tochigi (JP)

(21) Appl. No.: 14/555,963

(22) Filed: Nov. 28, 2014

Related U.S. Application Data
(63) Continuation of application No. PCT/JP2013/064364, filed on May 23, 2013.

(30) Foreign Application Priority Data
May 29, 2012 (JP) 2012-121704

(51) Int. Cl. H05G 2/00

(52) U.S. Cl. CPC H05G 2/008
USPC 250/504 R

(57) ABSTRACT

An extreme ultraviolet light generation device may be configured to generate extreme ultraviolet light by irradiating a target with a laser beam to turn the target into plasma. The extreme ultraviolet light generation device may comprise: a chamber provided with at least one through-hole; an optical system configured to introduce the laser beam into a predetermined region in the chamber through the at least one through-hole; and a target supply device configured to supply a powder target as the target to the predetermined region.

### TECHNICAL FIELD

The present disclosure relates to an extreme ultraviolet light generation device and an extreme ultraviolet light generation system.

### BACKGROUND ART

In recent years, as semiconductor processes become finer, transfer patterns for use in photolithographies of semiconductor processes have rapidly become finer. In the next generation, microfabrication at 70 nm to 45 nm, and further, microfabrication at 32 nm or less would be demanded. In order to meet the demand for microfabrication at 32 nm or less, for example, it is expected to develop an exposure apparatus in which a system for generating EUV light at a wavelength of approximately 13 nm is combined with a reduced projection reflective optical system.

Three types of EUV light generation systems have been proposed, which include an LPP (laser produced plasma) type system using plasma generated by irradiating a target material with a pulse laser beam, a DPP (discharge produced plasma) type system using plasma generated by electric discharge, and an SR (synchrotron radiation) type system using orbital radiation.

### SUMMARY

An extreme ultraviolet light generation device according to an aspect of the present disclosure may include: a chamber, an optical system, and a target supply device. The extreme ultraviolet light generation device may be configured to generate extreme ultraviolet light by irradiating a target with a laser beam to turn the target into plasma. The chamber may be provided with at least one through-hole. The optical system may be configured to introduce the laser beam into a predetermined region in the chamber through the at least one through-hole. The target supply device may be configured to supply a powder target as the target to the predetermined region.

An extreme ultraviolet light generation system according to another aspect of the present disclosure may include: a laser device, a chamber, an optical system, and a target supply device. The extreme ultraviolet light generation system may be configured to generate extreme ultraviolet light by irradiating a target with a laser beam to turn the target into plasma. The laser device may be configured to output the laser beam. The chamber may be provided with at least one through-hole. The optical system may be configured to introduce the laser beam into a predetermined region in the chamber through the at least one through-hole. The target supply device may be configured to supply a powder target as the target to the predetermined region.

### BRIEF DESCRIPTION OF THE DRAWINGS

Hereinafter, selected embodiments of the present disclosure will be described with reference to the accompanying drawings by way of example.

FIG. 1 schematically illustrates an exemplary configuration of an LPP type EUV light generation system.

FIG. 2 is a partial cross-sectional view schematically illustrating an exemplary configuration of the EUV light generation system according to a first embodiment.

FIG. 3 schematically illustrates an exemplary configuration of a target supply device shown in FIG. 2.

FIG. 4 schematically illustrates another exemplary configuration of the target supply device shown in FIG. 2.

FIG. 5A is a diagram for explaining an exemplary design of an aerodynamic lens shown in FIG. 4.

FIG. 5B shows the dimensions of each component of the designed aerodynamic lens.

FIG. 5C shows some parameters of the powder target in the plasma generation region in the case where the designed aerodynamic lens is used.

FIG. 5D shows the beam diameter of the powder target in each orifice of the designed aerodynamic lens.

FIG. 6 schematically illustrates an exemplary configuration of the laser device shown in FIG. 2.

FIG. 7 schematically illustrates an exemplary configuration of the target supply device that is used in a second embodiment.

FIG. 8 schematically illustrates an exemplary configuration of the target supply device that is used in a third embodiment.

FIG. 9 schematically illustrates an exemplary configuration of the target supply device that is used in a fourth embodiment.

FIG. 10 schematically illustrates an exemplary configuration of the target supply device that is used in a fifth embodiment.

FIG. 11 schematically illustrates an exemplary configuration of the EUV light generation system according to a sixth embodiment.

FIG. 12 schematically illustrates an exemplary configuration of the target supply device that is used in a seventh embodiment.

FIG. 13 schematically illustrates an exemplary configuration of the EUV light generation system according to an eighth embodiment.

FIG. 14 schematically illustrates an exemplary configuration of the EUV light generation device according to a ninth embodiment.

FIG. 15 schematically illustrates an exemplary configuration of the EUV light generation device according to a tenth embodiment.

FIG. 16A schematically illustrates an exemplary configuration of the laser device that is used in an eleventh embodiment. FIG. 16B is a graph showing a pulse waveform of the pulse laser beam that is outputted from a master oscillator. FIG. 16C is a graph showing a pulse waveform of the pulse laser beam that is outputted from a waveform adjuster. FIG. 16D is a graph showing a pulse waveform of the pulse laser beam that is outputted from an amplifier PA3.

FIG. 17A schematically illustrates an exemplary configuration of the waveform adjuster shown in FIG. 16A. FIG. 17B is a graph showing a pulse waveform of the pulse laser beam that is outputted from the master oscillator. FIG. 17C is a graph showing a waveform of a pulse voltage that is outputted from a high-voltage power source. FIG. 17D is a graph showing a pulse waveform of the pulse laser beam that is outputted from the waveform adjuster.

FIG. 18 schematically illustrates an exemplary configuration of a laser device that is used in a twelfth embodiment.

FIG. 19A schematically illustrates an exemplary configuration of a laser device that is used in a thirteenth embodiment.

FIG. 19B is a graph showing a pulse waveform of the pulse laser beam that is outputted from a second master oscillator.

FIG. 19C is a graph showing a pulse waveform of the pulse laser beam that is outputted from a first master oscillator.

FIG. 19D is a graph showing a pulse waveform of the pulse laser beam that is outputted from an optical path adjuster.

FIG. 19E is a graph showing a pulse waveform of the pulse laser beam that is outputted from the laser device.

FIG. 20 is a partial cross-sectional view schematically illustrating the EUV light generation system according to a fourteenth embodiment.

### EMBODIMENTS

### Contents

### 1. Overview

### 2. Description of Terms

### 3. Overview of Extreme Ultraviolet Light Generation System

3.1 Configuration

3.2 Operation

### 4. Extreme Ultraviolet Light Generation System Including Target Supply Device

4.1 Configuration

4.2 Operation

4.3 Effect

### 5. Target Supply Device That Supplies Powder Target

5.1 Target Supply Device Including Aerosol Generator

5.2 Target Supply Device Including Aerodynamic Lens

### 6. Laser Device

### 7. Others

7.1 Variation (1) of Target Supply Device

7.2 Variation (2) of Target Supply Device

7.3 Variation (3) of Target Supply Device

7.4 Variation (4) of Target Supply Device

7.5 Variation (5) of Target Supply Device

7.6 Variation (6) of Target Supply Device

7.7 Variation (1) of Chamber

7.8 Variation (2) of Chamber

7.9 Variation (3) of Chamber

7.10 Variation (1) of Laser Device

7.11 Variation (2) of Laser Device

7.12 Variation (3) of Laser Device

7.13 Variation (4) of Laser Device

Hereinafter, selected embodiments of the present disclosure will be described in detail with reference to the accompanying drawings. The embodiments to be described below are merely illustrative in nature and do not limit the scope of the present disclosure. Further, the configuration(s) and operation(s) described in each embodiment are not all essential in implementing the present disclosure. Corresponding elements may be referenced by corresponding reference numerals and characters, and duplicate descriptions thereof may be omitted.

### 1. Overview

In an LPP type EUV light generation device, a target may be supplied from a target supply device into a chamber, and a pulse laser beam outputted from a laser device may be focused on the target, whereby the target may be turned into plasma. From the plasma, rays of light including EUV light may be emitted. The EUV light thus emitted may be collected by an EUV collector mirror disposed in the chamber and may be outputted to an exposure apparatus or the like.

In the LLP EUV light generation device, a target material might be melted by heat in the target supply device and the target might be supplied into the chamber in a form of a droplet. In the EUV light generation device, the droplet may be broken down into a diffused target by being irradiated with a pre-pulse laser beam and the diffused target may be turned into plasma by being irradiated with a main pulse laser beam. Since the breakdown of the droplet target by the pre-pulse laser beam allows the target to have an appropriate density, the target can be efficiently turned into plasma by the main pulse laser beam.

The target material supplied into the chamber might contaminate the EUV collector mirror. Therefore, it might not be desirable to supply an excessive amount of the target material into the chamber. In order to reduce the amount of the target material supplied into the chamber, it might be desirable that the diameter of the droplet target be a minutely small diameter of about 20 μm, for example. Further, it might be desirable that the diameter of a nozzle from which the minutely-small-diameter droplet target is outputted be a minutely small diameter of about 10 μm, for example.

However, in the target supply device, a part of the target material melted by heat might form an impurity by being oxidized or reacting with a material constituting a container or passageway for the target material. This impurity might adhere to the aforementioned minutely-small-diameter nozzle to clog the nozzle or destabilize the direction of the droplet target outputted from the nozzle.

In one aspect of the present disclosure, a powder target may be supplied into the chamber. This may make it possible to supply a powder target at an appropriate density to a plasma generation region without breaking down the droplet target with a pre-pulse laser beam. Furthermore, in the case of the powder target, it may not be necessary to make the nozzle as small in diameter as it would be if minutely-small-diameter droplets were supplied. Therefore, clogging of the nozzle and change in the direction of the target can be suppressed. Further, in the case of the powder target, it can be unnecessary to heat the target material to a temperature that is equal to or higher than the melting point of the target material in the target supply device.

### 2. Description of Terms

A “pulse laser beam” may refer to a laser beam including a plurality of pulses.

A “target material” may refer to a material, such as tin (Sn), gadolinium (Gd), or terbium (Tb), which may be turned into plasma by being irradiated with at least one pulse of the pulse laser beam to emit EUV light from the plasma.

A “target” may refer to a mass, containing a minutely small amount of the target material, which is supplied into the chamber by the target supply device and irradiated with the pulse laser beam. This mass can be in the form of a solid, powder, liquid, or gas.

A “powder target” may refer to a target containing a plurality of fine solid particles.

An “aerosol” may refer to a dispersion system in which fine solid particles are suspended within the gas.

### 3. Overview of the Extreme Ultraviolet Light Generation System

3.1 Configuration

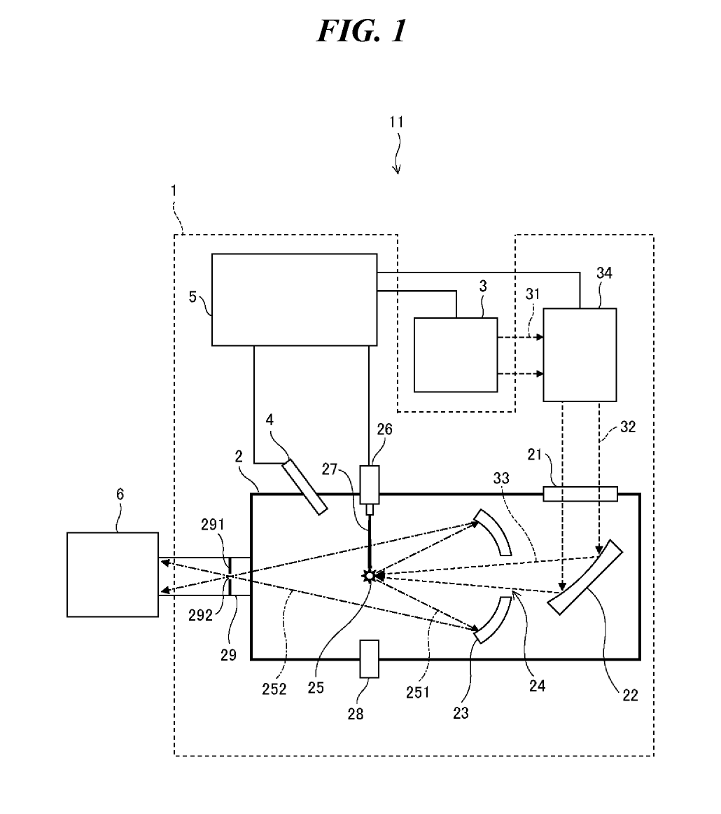

FIG. 1 schematically illustrates an exemplary configuration of an LPP type EUV light generation system. An EUV light generation device 1 may be used with at least one laser device 3. Hereinafter, a system that includes the EUV light generation device 1 and the laser device 3 may be referred to as an EUV light generation system 11. As shown in FIG. 1 and described in detail below, the EUV light generation system 11 may include a chamber 2 and a target supply device 26. The chamber 2 may be sealed airtight. The target supply device 26 may be mounted onto the chamber 2, for example, to penetrate a wall of the chamber 2. A target material to be supplied by the target supply device 26 may include, but is not limited to, tin, terbium, gadolinium, lithium, xenon, or a combination of any two or more of them.

The chamber 2 may have at least one through-hole or opening formed in its wall. A window 21 may be located at the through-hole or opening. A pulse laser beam 32 may travel through the window 21. In the camber, an EUV collector mirror 23 having a spheroidal reflective surface may be provided. The EUV collector mirror 23 may have a first focusing point and a second focusing point. The reflective surface of the EUV collector mirror 23 may have a multi-layered reflective film in which molybdenum layers and silicon layers are alternately laminated. The EUV collector mirror 23 may be positioned such that the first focusing point is positioned in a plasma generation region 25 and the second focusing point is positioned in an intermediate focus (IF) region 292. The EUV collector mirror 23 may have a through-hole 24, formed at the center thereof, through which a pulse laser beam 33 travels.

The EUV light generation device 1 may further include an EUV light generation control device 5 and a target sensor 4. The target sensor 4 may have an imaging function and detect at least one of the presence, trajectory, position, and speed of a target.

Furthermore, the EUV light generation device 1 may include a connection part 29 for allowing the interior of the chamber 2 to be in communication with the interior of the exposure apparatus 6. In the connection part 29, a wall 291 having an aperture may be provided. The wall 291 is preferably positioned such that the second focusing point of the EUV collector mirror 23 lies in the aperture formed in the wall 291.

The EUV light generation device 1 may also include a laser beam direction control unit 34, a laser beam focusing mirror 22, and a target collector 28 for collecting the target 27. The laser beam direction control unit 34 may include an optical system (not separately shown) for defining the direction of the pulse laser beam and an actuator (not separately shown) for adjusting the position or the posture of the optical system.

3.2 Operation

With continued reference to FIG. 1, a pulse laser beam 31 outputted from the laser device 3 may pass through the laser beam direction control unit 34 and be outputted therefrom as the pulse laser beam 32. The pulse laser beam 32 may travel through the window 21 and enter into the chamber 2. The pulse laser beam 32 may travel inside the chamber 2 along at least one beam path, be reflected by the laser beam focusing mirror 22, and strike at least one target 27 as a pulse laser beam 33.

The target supply device 26 may be configured to output the target(s) 27 toward the plasma generation region 25 in the chamber 2. The target 27 may be irradiated with at least one pulse of the pulse laser beam 33. Upon being irradiated with the pulse laser beam 33, the target 27 may be turned into plasma, and rays of light 251 may be emitted from the plasma. At least EUV light included in the light 251 may be reflected selectively by the EUV collector mirror 23. The EUV light 252 reflected by the EUV collector mirror 23 may travel through the intermediate focus region 292 and be outputted to the exposure apparatus 6.

The EUV light generation control device 5 may be configured to integrally control the EUV light generation system 11. The EUV light generation control device 5 may be configured to process image data of the target 27 captured by the target sensor 4. Further, the EUV light generation control device 5 may be configured to control at least one of: the timing when the target 27 is outputted; and the direction into which the target 27 is outputted. Furthermore, the EUV light generation control device 5 may be configured to control at least one of: the timing when the laser device 3 oscillates; the direction in which the pulse laser beam 32 travels; and the position at which the pulse laser beam 33 is focused. The various controls mentioned above are merely examples, and other controls may be added as necessary.

### 4. Extreme Ultraviolet Light Generation System Including Target Supply Device

4.1 Configuration

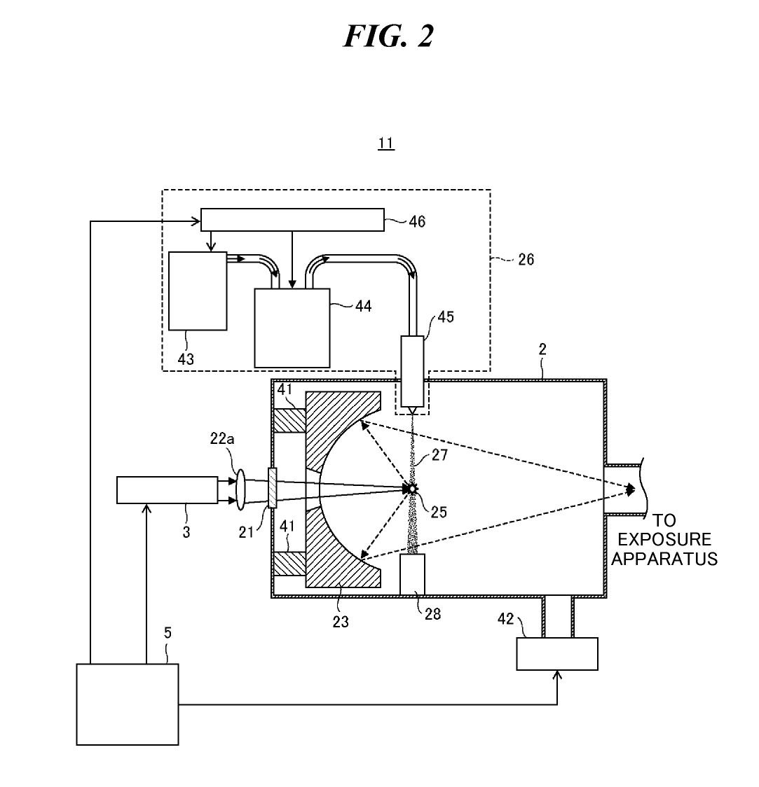

FIG. 2 is a partial cross-sectional view schematically illustrating an exemplary configuration of the EUV light generation system 11 according to a first embodiment. As shown in FIG. 2, the EUV collector mirror 23, a target collector 28, and an EUV collector mirror holder 41 may be provided within the chamber 2.

The EUV collector mirror 23 may be fixed to the chamber 2 via the EUV collector mirror holder 41. The target collector 28 may be disposed on an extension line of the trajectory of the target 27 and may collect those of the targets 27 which were not irradiated with the pulse laser beam.

The target supply device 26 and an exhaust device 42 may be mounted to the chamber 2. The exhaust device 42 may be a pump which exhausts gases from the chamber 2 so that the pressure inside the chamber 2 may be kept to a predetermined pressure that is less than atmospheric pressure. The target supply device 26 may include a carrier gas supplier 43, an aerosol generator 44, a powder output unit 45, and a control unit 46.

The carrier gas supplier 43 may supply a carrier gas to the aerosol generator 44 under atmospheric pressure or greater pressure. The carrier gas may be used for carrying a powder containing the target material. The aerosol generator 44 may generate an aerosol by dispersing the powder containing the target material in the carrier gas supplied by the carrier gas supplier 43. The powder output unit 45 may be fixed to the chamber 2. The powder output unit 45 may supply the powder contained in the aerosol generated by the aerosol generator 44 to the plasma generation region 25 in the chamber 2.

The control unit 46 may control operations of the carrier gas supplier 43 and the aerosol generator 44. Force with which the aerosol is supplied from the aerosol generator 44 into the chamber 2 may be given by a differential pressure between the pressure inside the chamber 2 as adjusted by the exhaust device 42 and the pressure of the carrier gas supplied by the carrier gas supplier 43.

A laser beam focusing optical system 22a may be disposed between the laser device 3 and the chamber 2. The laser beam focusing optical system 22a may include at least one lens or mirror. The laser beam focusing optical system 22a may focus, on the plasma generation region 25, the pulse laser beam outputted from the laser device 3.

4.2 Operation

The EUV light generation control device 5 may cause the exhaust device 42 to be driven so that gasses in the chamber 2 may be exhausted. Next, the EUV light generation control device 5 may cause the carrier gas supplier 43 to be driven via the control unit 46 of the target supply device 26 so that the carrier gas may be introduced into the aerosol generator 44. Further, the EUV light generation control device 5 may cause the aerosol generator 44 to be driven via the control unit 46 to supply the powder containing the target material into a container of the aerosol generator 44 or to give vibrations to the container of the aerosol generator 44. The aerosol generated by the aerosol generator 44 may be forced into the chamber 2 via the powder output unit 45 by the differential pressure between the pressure of the carrier gas and the pressure inside the chamber 2. A powder target 27 contained in the aerosol may reach the plasma generation region 25.

The aforementioned EUV light generation control device 5 may cause the laser device 3 to be driven so that a pulse laser beam may be outputted from the laser device 3. The pulse laser beam outputted from the laser device 3 may travel via the laser beam focusing optical system 22a and the window 21 and reach the plasma generation region 25. This may cause the pulse laser beam to strike the powder target 27 so that the powder target 27 may be turned into plasma to generate EUV light.

4.3 Effect

According to the EUV light generation device, the powder target 27 is supplied to the plasma generation region 25. This may make it possible to supply the powder target 27 at an appropriate density to the plasma generation region 25 without breaking down a droplet target with a pre-pulse laser beam.

Furthermore, in the case of the powder target 27, it is not necessary to make the nozzle as small in diameter as it would be if minutely-small-diameter droplets were supplied. Therefore, clogging of the nozzle and change in the direction of the target can be suppressed.

Further, in the case of the powder target 27, it may be unnecessary to heat the target material to a temperature that is equal to or higher than the melting point of the target material in the target supply device 26. The melting point of the target material can be 232° C. in a case where the target material is tin, 1312° C. in a case where the target material is gadolinium, or 1356° C. in a case where the target material is terbium.

5. Target Supply Device that Supplies Powder Target

5.1 Target Supply Device Including Aerosol Generator

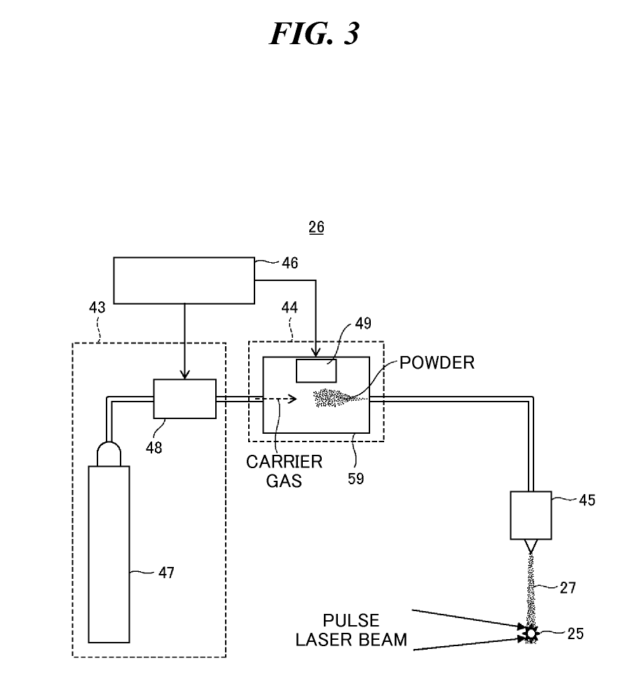

FIG. 3 schematically illustrates an exemplary configuration of the target supply device 26 shown in FIG. 2. The carrier gas supplier 43 of the target supply device 26 may include a high-pressure gas cylinder 47 and a mass flow controller 48. Further, the aerosol generator 44 may include a powder generation mechanism 49 and a container 59. The aerosol generator 44 may include the below-mentioned power supply mechanism instead of the powder generation mechanism 49.

The high-pressure gas cylinder 47 may contain a carrier gas such as a helium gas (He), an argon gas (Ar), a hydrogen gas (H₂), a mixture of the helium gas and the hydrogen gas, or a mixture of the argon gas and the hydrogen gas. The mass flow controller 48 may control, in accordance with a control signal from the control unit 46, the flow rate of the carrier gas that is supplied from the high-pressure gas cylinder 47 to the aerosol generator 44.

The powder generation mechanism 49 may be a mechanism that turns a target material into a powder and supplies the powder into the container 59 of the aerosol generator 44. The powder generation mechanism 49 may generate the powder, for example, by a sputtering method, a laser ablation method, or the like. The amount and particle diameter of the powder that is generated by the powder generation mechanism 49 may be controlled in accordance with control signals from the control unit 46. The aerosol generator 44 may generate the aerosol by dispersing, in the carrier gas supplied by the carrier gas supplier 43, the powder containing the target material generated by the powder generation mechanism 49. Further, the powder generation mechanism 49 may be replaced by the below-mentioned powder supply mechanism that has stored in advance therein the powder containing the target material and supplies the powder by a method such as a gas raising method or a dropping method.

The powder output unit 45 may output, toward the plasma generation region 25 in the chamber 2, a powder target 27 contained in the aerosol generated by the aerosol generator 44. The powder target 27 may be outputted in a form of a beam. The powder target 27 may be irradiated with a pulse laser beam that is outputted from the laser device 3, and a portion of the powder target 27 that has been irradiated with the pulse laser beam may be turned into plasma to generate EUV light.

The target material, diffused along with the generation of plasma, may adhere to the reflective surface of the EUV collector mirror 23 shown in FIG. 2 to reduce the reflectance of EUV light by the EUV collector mirror 23. Therefore, in the case where the target material contains tin (Sn), it is preferable that the carrier gas contain the hydrogen gas. As indicated in Formula 1 below, the hydrogen gas can become a hydrogen radical (H*) upon being irradiated with the EUV light. As indicated in Formula 2 below, this hydrogen radical and tin having adhered to the EUV collector mirror 23 may react with each other to generate stannane (SnH₄), which takes the form of a gas at normal temperature.

H₂→2H* Formula 1

Sn+4H*→SnH₄ Formula 2

This causes the target material having adhered to the EUV collector mirror 23 to be etched so that the life of the EUV collector mirror 23 can be lengthened.

5.2 Target Supply Device Including Aerodynamic Lens

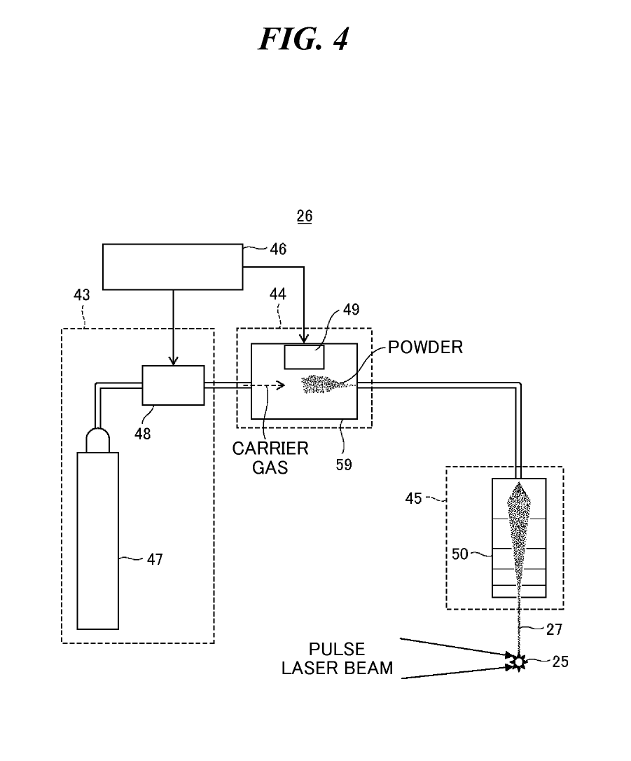

FIG. 4 schematically illustrates another exemplary configuration of the target supply device 26 shown in FIG. 2. The powder output unit 45 of the target supply device 26 may include an aerodynamic lens 50. The aerodynamic lens 50 may have a structure in which several orifice plates are arranged in a row. The aerodynamic lens 50 may introduce the aerosol generated by the aerosol generator 44 on a high-pressure side into the chamber 2 on a low-pressure side. The aerodynamic lens 50 may form the powder contained in the aerosol to a beam-shape, and may output the powder to the plasma generation region 25 in the chamber 2.

Use of the aerodynamic lens 50 may make it possible to cause much of the powder target 27 to reach the plasma generation region 25 by suppressing dispersion of the powder target 27 in the chamber 2. Therefore, it may be possible to improve the efficiency in the use of the powder target 27. Further, use of the aerodynamic lens 50 may make it possible to place the powder output unit 45 and the plasma generation region 25 at a long distance (WD) from each other.

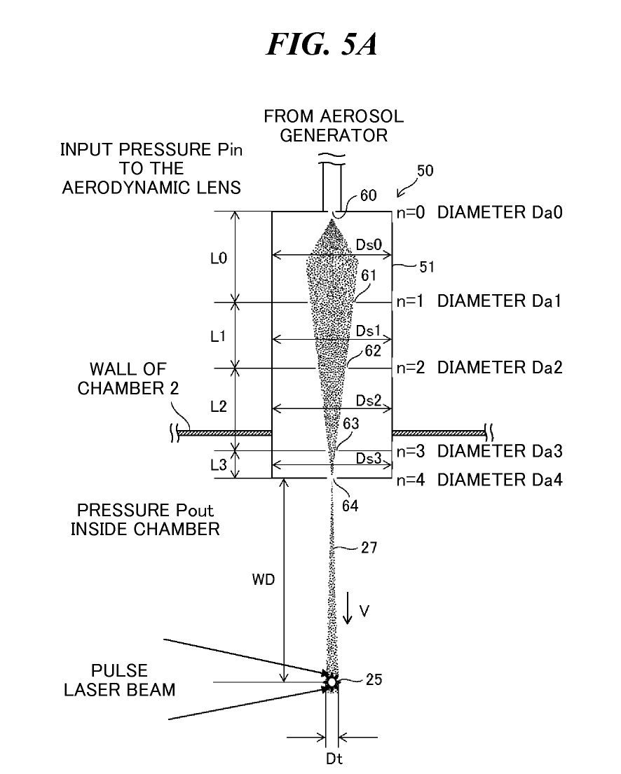

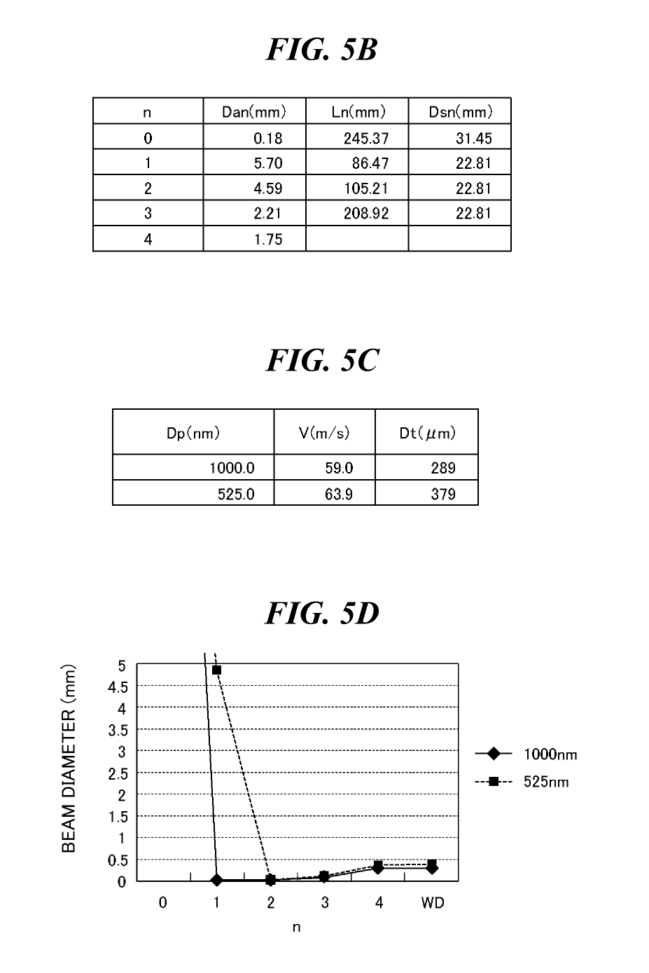

FIG. 5A is a diagram for explaining an exemplary design of the aerodynamic lens 50 shown in FIG. 4. FIG. 5B shows the dimensions of each component of the designed aerodynamic lens 50. FIG. 5C shows some parameters of the powder target in the plasma generation region in the case where the designed aerodynamic lens 50 is used. FIG. 5D shows the beam diameter of a powder target in each orifice of the designed aerodynamic lens 50 and in a position at the distance WD from a fourth orifice 64. The position at the distance WD from the fourth orifice 64 may correspond to the plasma generation region 25.

As shown in FIG. 5A, the aerodynamic lens 50 may include a tube 51 having an opening 60 formed at one end thereof and an orifice formed at the other end thereof. The opening 60 may communicate with the aerosol generator 44, and the orifice may communicate with the chamber 2. In the present design, the orifice, which communicates with the chamber 2, may be the fourth orifice 64. Between the opening 60 and the fourth orifice 64, the tube 51 may have a first orifice 61, a second orifice 62, and a third orifice 63 in this order from the side of the opening 60.

Here, suppose Da0 is the diameter of the opening 60 (n=0), Da1 is the diameter of the first orifice 61 (n=1), Da2 is the diameter of the second orifice 62 (n=2), Da3 is the diameter of the third orifice 63 (n=3), and Da4 is the diameter of the fourth orifice 64 (n=4). The position n of the opening 60 may be set to n=0, the position n of the first orifice 61 may be set to n=1, the position n of the second orifice 62 may be set to n=2, the position n of the third orifice 63 may be set to n=3, and the position n of the fourth orifice 64 may be set to n=4. Further, suppose L0 is the distance between the opening 60 and the first orifice 61, L1 is the distance between the first orifice 61 and the second orifice 62, L2 is the distance between the second orifice 62 and the third orifice 63, and L3 is the distance between the third orifice 63 and the fourth orifice 64. Further, suppose Ds0 is the inner diameter of the tube 51 between the opening 60 and the first orifice 61, Ds1 is the inner diameter of the tube 51 between the first orifice 61 and the second orifice 62, Ds2 is the inner diameter of the tube 51 between the second orifice 62 and the third orifice 63, and Ds3 is the inner diameter of the tube 51 between the third orifice 63 and the fourth orifice 64.

Further, the carrier gas may be an argon gas, and the powder contained in the aerosol may be a powder composed of solid fine particles of tin whose diameter Dp is in the range of 50 nm to 1,000 nm. Further, the distance WD from the fourth orifice 64 to the plasma generation region 25 may be 100 mm. Further, the input pressure Pin to the aerodynamic lens 50 may be 101,325 Pa and the pressure Pout inside the chamber 2 may be 0.1 Pa.

FIGS. 5B through 5D show results obtained by designing the aerodynamic lens 50 so that the beam diameter Dt of the powder target 27 at the plasma generation region 25 is in the range of 280 μm to 400 μm and so that the flow rate V of the powder target 27 is in the range of 59 m/s to 130 m/s. The aforementioned Da0 to Da4, L0 to L3, and Ds0 to Ds3 may take on the values shown in FIG. 5B. As shown in FIG. 5C, as for fine particles of 1,000.0 nm in diameter Dp, the flow rate can be 59.0 m/s and the beam diameter of the powder target 27 can be 289 μm. Further, as for fine particles of 525.0 nm in diameter Dp, the flow rate can be 63.9 m/s and the beam diameter of the powder target 27 can be 379 μm. FIG. 5D shows the beam diameter in each orifice and the beam diameter in the position at the distance WD from the fourth orifice 64.

Such a powder target 27 may, for example, be irradiated with a pulse laser beam of 400 μm in focus spot diameter at a repetition frequency of 50 kHz to 100 KHz. This makes it possible to generate EUV light at a repetition frequency of 50 kHz to 100 KHz. The focus spot diameter is the diameter of a portion having an intensity of 1/e² or higher of the peak intensity in an intensity distribution of the focus spot.

Further, the cycle period of a pulse laser beam at a repetition frequency of 100 kHz is 10 μs. Therefore, if the flow rate V of the powder target 27 is 59.0 m/s, the powder target 27 may be irradiated with one pulse of the pulse laser beam every time the powder target 27 travels 590 μm. As mentioned above, the beam diameter Dt of the powder target 27 in the plasma generation region 25 can be in the range of 280 μm to 400 μm. Therefore, in a case where the focus spot diameter of the pulse laser beam is 400 μm, much of the target material that is supplied into the chamber 2 can be used for generation of EUV light. Furthermore, the diameter Da0 of the opening 60, the diameter Da1 of the first orifice 61, the diameter Da2 of the second orifice 62, the diameter Da3 of the third orifice 63, and the diameter Da4 of the fourth orifice 64 are all in the range of 0.18 to 1.75 mm and can be 180 times as large as the particle diameter of 500 nm to 1,000 nm of the tin fine particles. This makes it possible to suppress jamming of the tin fine particles in the opening 60 or the first to fourth orifices 61 to 64. Also, it is possible to suppress change in the direction in which the target travels.

A method of forming the powder target 27 into a beam form is not limited to a method using the aerodynamic lens 50. The direction of movement of a powder may be controlled by Coulomb's force generated by charging the powder in advance and applying a potential to electrodes provided around a flow channel of the powder.

A pulse laser beam generated by a CO₂ laser device has a wavelength of approximately 10.6 μm and might therefore pass through fine particles of less than 30 nm in diameter. Therefore, it may be preferable that the diameter Dp of each of the fine particles contained in the aerosol be 30 nm or larger.

Further, it may be preferable that the distance between particles of the powder contained in the aerosol be 20 μm or less. Further, it may be preferable that the density of the target material contained in the aerosol be in the range of 6×10¹⁷ atoms/cm³ or more to 6×10¹⁸ atoms/cm³ or less. For this reason, it may be preferable that the maximum value of the diameter Dp of each of the fine particles contained in the aerosol be in the range of 510 nm or more to 1,110 nm or less.

### 6. Laser Device

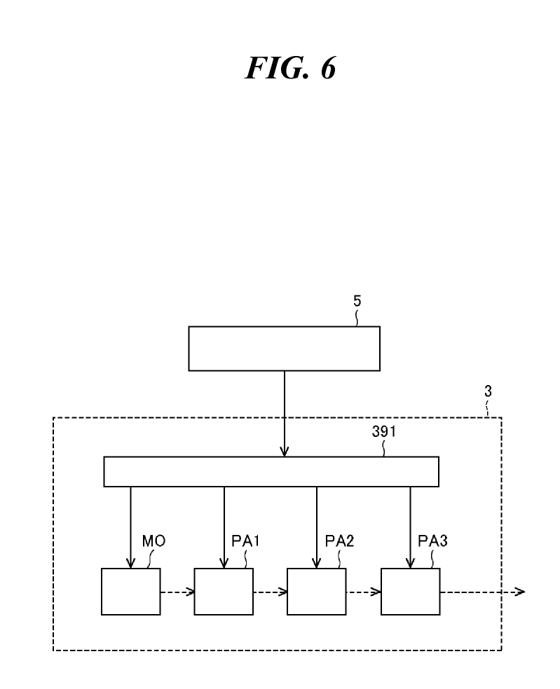

FIG. 6 schematically illustrates an exemplary configuration of the laser device 3 shown in FIG. 2. The laser device 3 may include a master oscillator MO, a plurality of amplifiers PA1, PA2, and PA3, and a control unit 391.

The master oscillator MO may be a CO₂ laser device using a CO₂ gas as a laser medium. The plurality of amplifiers PA1, PA2, and PA3 may be arranged in series in an optical path of a pulse laser beam that is outputted from the master oscillator MO. The plurality of amplifiers PA1, PA2, and PA3 may, for example, each include a laser chamber (not illustrated) containing a CO₂ gas as a laser medium, a pair of electrodes (not illustrated) disposed in the laser chamber, and a power source (not illustrated) that applies a voltage between the pair of electrodes. The control unit 391 may cause a pulse laser beam to be outputted by controlling the master oscillator MO and the plurality of amplifiers PA1, PA2, and PA3 in accordance with a control signal from the EUV light generation control device 5.

### 7. Others

7.1 Variation (1) of Target Supply Device

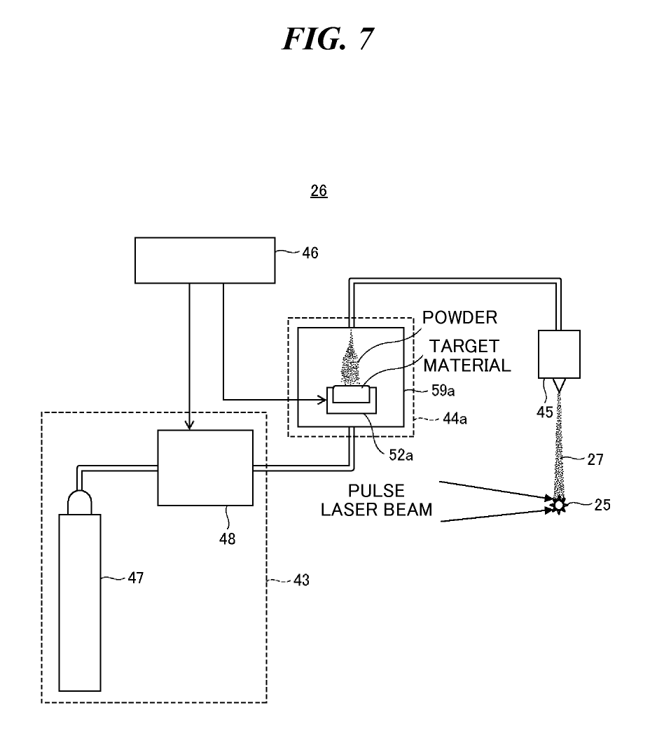

FIG. 7 schematically illustrates an exemplary configuration of the target supply device 26 that is used in a second embodiment. In the second embodiment, a container 59a of an aerosol generator 44a may accommodate a crucible 52a including a heating device (not illustrated) for heating a target material. The crucible 52a may gasify the target material at a constant rate by heating it in accordance with a control signal from the control unit 46. The target material thus gasified may be turned into a powder by being cooled at a point distant from the crucible 52. The target material thus turned into a powder may be dispersed in the carrier gas and supplied via the powder output unit 45 as a powder target 27 into the chamber 2. The other points may be the same as the first embodiment.

7.2 Variation (2) of Target Supply Device

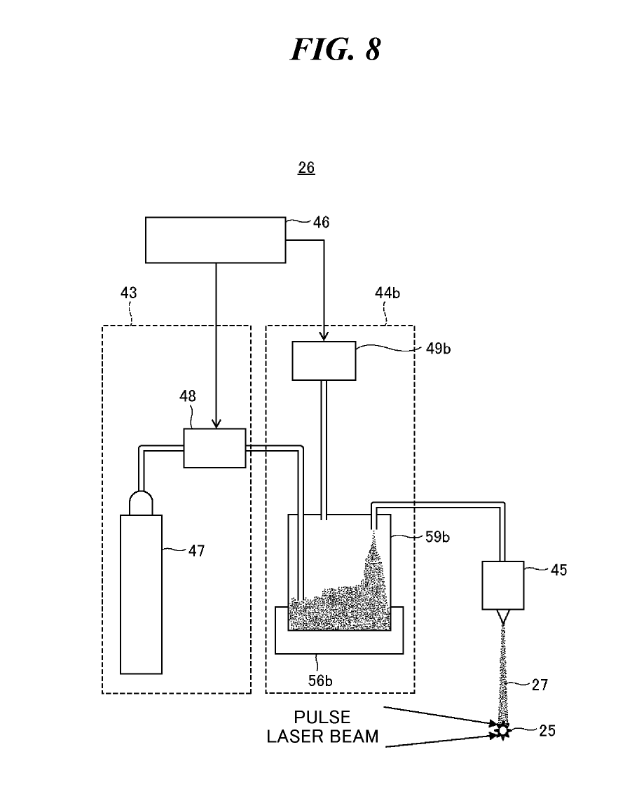

FIG. 8 schematically illustrates an exemplary configuration of the target supply device 26 that is used in a third embodiment. In the third embodiment, an aerosol generator 44b may include a powder supply mechanism 49b. The powder supply mechanism 49b may have stored in advance therein a powder containing the target material and may supply the powder into a container 59b of the aerosol generator 44b in accordance with a control signal from the control unit 46.

The aerosol generator 44b may include a vibration mechanism 56b for suppressing agglomeration of the powder in the container 59b. The vibration mechanism 56b may apply ultrasonic vibrations, electromagnetic vibrations, or mechanical vibrations to the container 59b of the aerosol generator 44b. The other points may be the same as the first embodiment.

7.3 Variation (3) of Target Supply Device

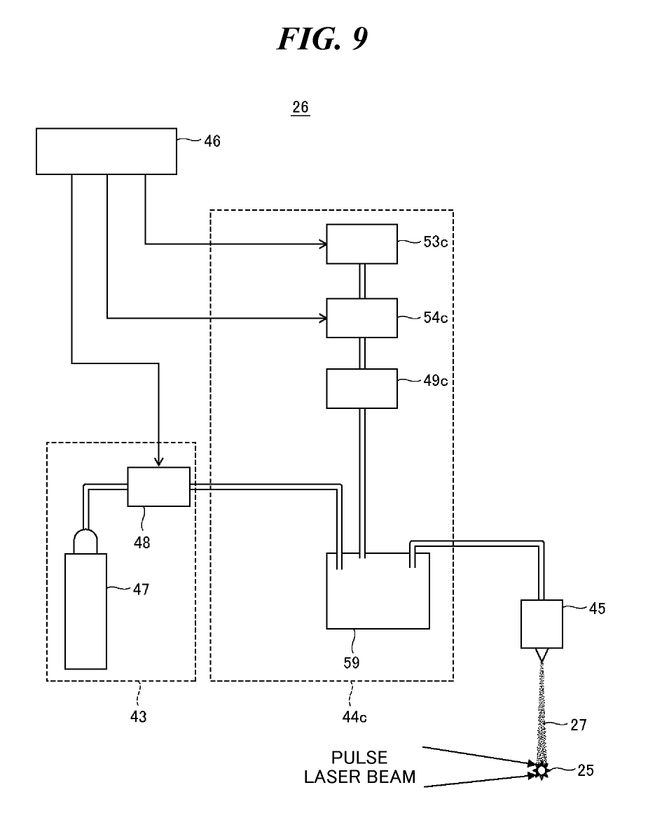

FIG. 9 schematically illustrates an exemplary configuration of the target supply device 26 that is used in a fourth embodiment. In the fourth embodiment, an aerosol generator 44c may include a pulverizer 53c, a classifier 54c, and a powder supply mechanism 49c. In accordance with a control signal from the control unit 46, the pulverizer 53c may generate a powder by pulverizing or crushing a solid target material and may supply the powder to the classifier 54c. In accordance with a control signal from the control unit 46, the classifier 54c may supply, to the powder supply mechanism 49c, those of the particles of the powder supplied from the pulverizer 53c which have particle diameters in a predetermined range. The other points may be the same as the first embodiment.

7.4 Variation (4) of Target Supply Device

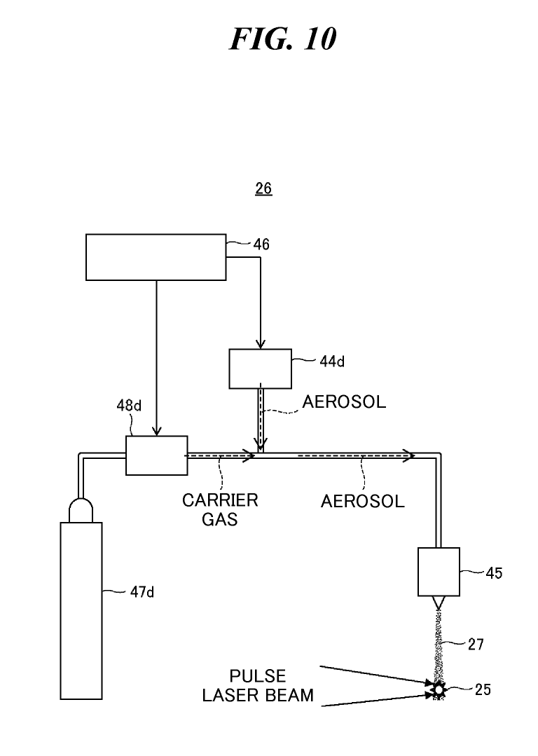

FIG. 10 schematically illustrates an exemplary configuration of the target supply device 26 that is used in a fifth embodiment. In the fifth embodiment, an aerosol generated by an aerosol generator 44d and a carrier gas supplied from a high-pressure gas cylinder 47d and a mass flow controller 48d may be mixed with each other in a pipe. Then the resulting mixture may be supplied via the powder output unit 45 to the plasma generation region 25 in the chamber 2. The other points may be the same as the first embodiment.

7.5 Variation (5) of Target Supply Device

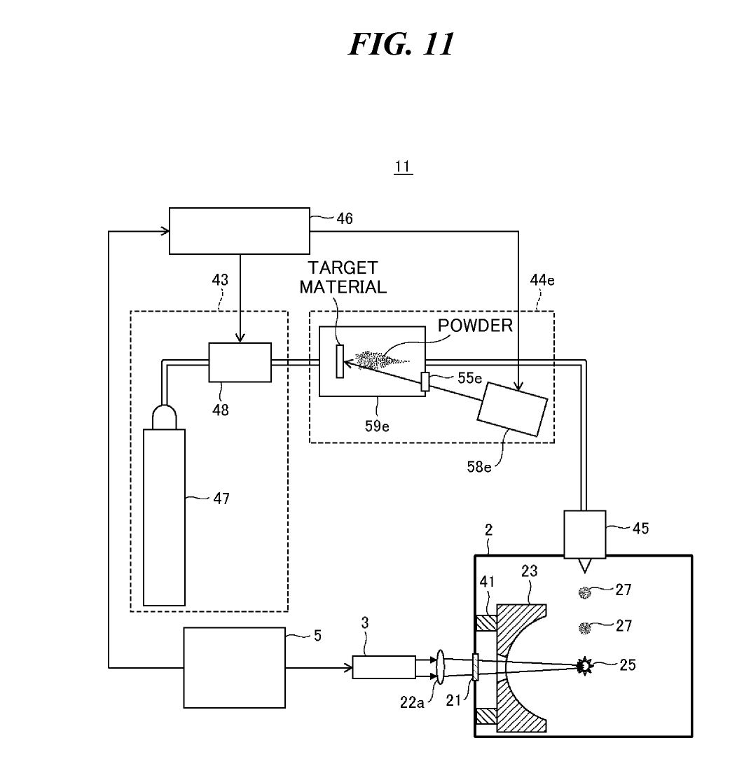

FIG. 11 schematically illustrates an exemplary configuration of the EUV light generation system 11 according to a sixth embodiment. In the sixth embodiment, an aerosol generator 44e may generate a powder target 27 in the form of pulses. Specifically, the aerosol generator 44e may include a pulse heating device 58e. The pulse heating device 58e may be a device that outputs a pulse laser beam in accordance with a control signal from the control unit 46.

The pulse laser beam outputted from the pulse heating device 58e may pass through a condensing lens (not illustrated) and a window 55e provided in the container 59e of the aerosol generator 44e. The pulse laser beam may be focused with a predetermined focusing diameter on a solid or liquid target material placed in a container 59e. This may cause the target material to be heated by the pulse laser beam in the container 59e of the aerosol generator 44e and a certain amount of the target material may be gasified. The target material thus gasified can be cooled so that a powder containing the target material can be generated in the form of pulses. The powder thus generated in the form of pulses can be supplied as a powder target 27 in the form of pulses via the powder output unit 45 into the chamber 2. The EUV light generation control device 5 may control the laser device 3 so that the powder target 27 may be irradiated with a pulse laser beam at the timing at which the powder target 27 in the form of pulses reaches the plasma generation region 25. The other points may be the same as the first embodiment. The pulse heating device 58e may be a device that outputs an electronic beam, an ion beam, or the like in the form of pulses. In this case, the window 55e is not needed, and the pulse heating device may be mounted directly onto the container 59e.

7.6 Variation (6) of Target Supply Device

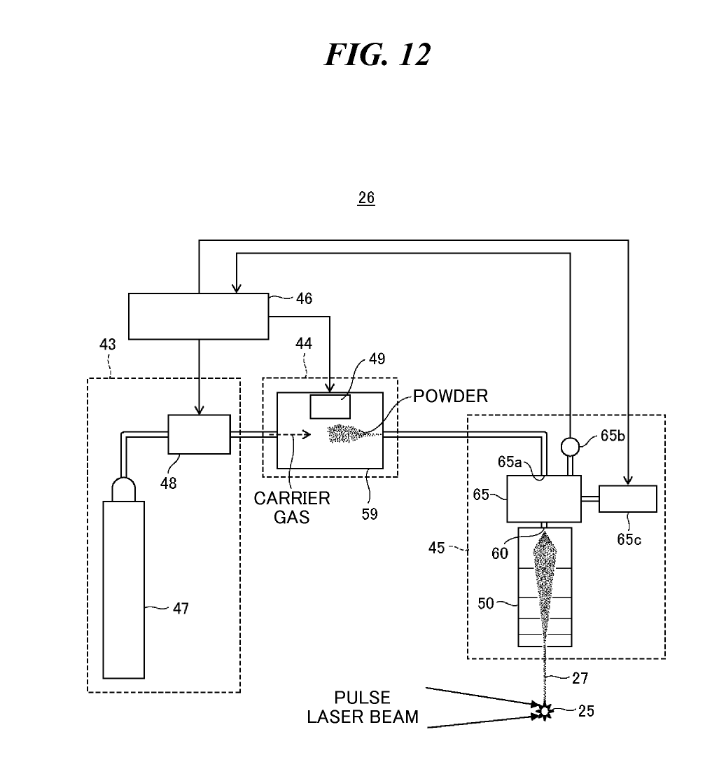

FIG. 12 schematically illustrates an exemplary configuration of the target supply device 26 according to a seventh embodiment. In the seventh embodiment, the powder output unit 45 including the aerodynamic lens 50 may further include an aerosol storage room 65 located further upstream of the target material than the aerodynamic lens 50.

The aerosol storage room 65 may have an inlet 65a through which an aerosol generated in the aerosol generator 44 flows in. The aerosol storage room 65 may communicate with the aerodynamic lens 50 via the opening 60 of the aerodynamic lens 50. A pressure sensor 65b and an exhaust device 65c may be disposed with the aerosol storage room 65.

The pressure sensor 65b may detect the pressure inside the aerosol storage room 65. The pressure sensor 65b may be connected to the control unit 46 via a signal line. The control unit 46 may read the pressure inside the aerosol storage room 65 as detected by the pressure sensor 65b. The exhaust device 65c may exhaust inside the aerosol storage room 65. The exhaust device 65c may be connected to the control unit 46 via a signal line. In accordance with the pressure inside the aerosol storage room 65 as detected by the pressure sensor 65b, the control unit 46 may control the exhaust device 65c so that the value of the pressure inside the aerosol storage room 65 falls within a desired range. A filter (not illustrated) may be disposed between the exhaust device 65c and the aerosol storage room 65, and passage of the target material may be limited by this filter.

According to this configuration, by controlling the pressure inside the aerosol storage room 65, an appropriate operation pressure for the aerodynamic lens 50 to generate a desired powder target 27 can be applied to the aerodynamic lens 50. Further, the operation pressure that is applied to the aerodynamic lens 50 can be controlled separately from the pressure inside the aerosol generator 44 for generating the aerosol. Further, even in a case where the amount of the aerosol generated in the aerosol generator 44 changes, change in the amount of the aerosol supplied to the aerodynamic lens 50 can be suppressed. The other points may be the same as the first embodiment.

7.7 Variation (1) of Chamber

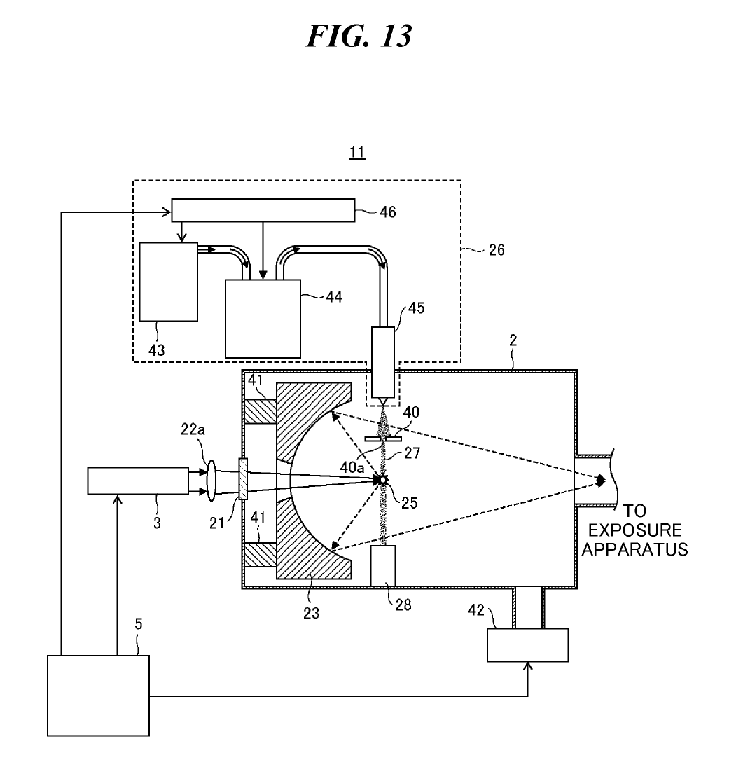

FIG. 13 schematically illustrates an exemplary configuration of the EUV light generation system 11 according to an eighth embodiment. In the eighth embodiment, the chamber 2 may have a beam shaping plate 40 having an aperture 40a formed therein. The beam shaping plate 40 may be held by a holder (not illustrated) between the powder output unit 45 and the plasma generation region 25. The aperture 40a may be located on the trajectory of the powder target 27. The diameter of the aperture 40a may be smaller than the beam diameter of the powder target 27 having reached the aperture 40a and an area therearound.

The powder target 27 outputted from the powder output unit 45 may travel substantially straight through the chamber 2 to reach the aperture 40a and the area therearound. Upon reaching the aperture 40a, the powder target 27 may pass through the aperture 40a and may travel substantially straight toward the plasma generation region 25. Upon reaching the area around the aperture 40a, the powder target 27 may collide with the beam shaping plate 40. Upon colliding with the beam shaping plate 40, the powder target 27 may not be able to pass through the aperture 40a. Thereby the beam diameter of the powder target 27 having passed through the aperture 40a may become smaller than the beam diameter of the powder target 27 having reached the aperture 40a and the area therearound.

According to this configuration, the beam diameter of the powder target 27 can be further adjusted. Further, the shape of a beam cross-section of the powder target 27 can be also adjusted by the shape of the aperture 40a. The other points may be the same as the first embodiment.

7.8 Variation (2) of Chamber

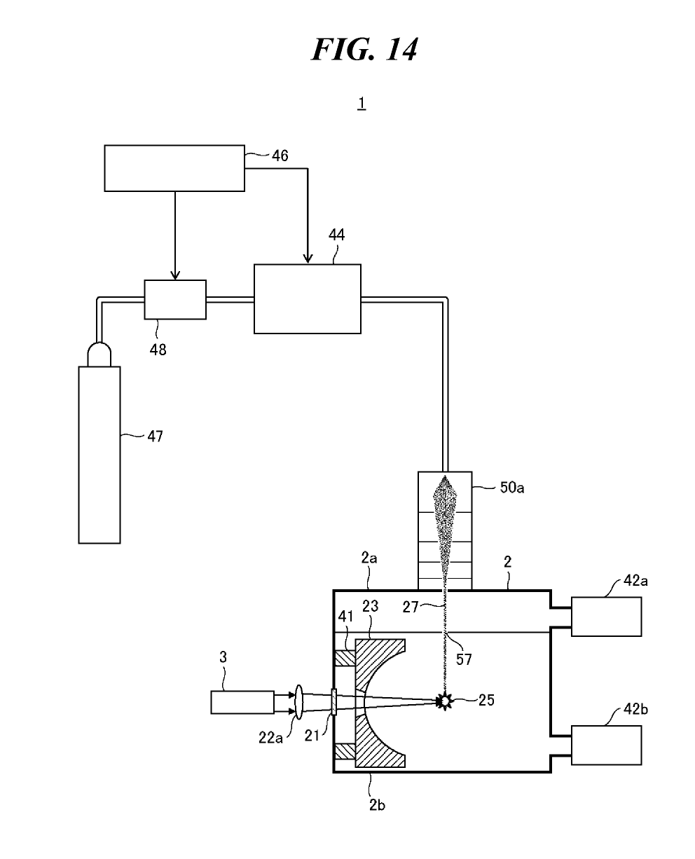

FIG. 14 schematically illustrates an exemplary configuration of the EUV light generation device 1 according to a ninth embodiment. In the ninth embodiment, the chamber 2 may have a low-vacuum chamber 2a and a high-vacuum chamber 2b that are separated from each other by a partition wall. The partition wall may have an orifice 57 provided therein. An exhaust device 42a and an exhaust device 42b may be connected to the low-vacuum chamber 2a and the high-vacuum chamber 2b, respectively. Gases in the chamber 2 may be exhausted so that the degree of vacuum in the high-vacuum chamber 2b is higher than in the low-vacuum chamber 2a. The “high vacuum” may be a state in which the pressure is lower. The aerodynamic lens 50 included in the target supply device 26 may be open toward the low-vacuum chamber 2a of the chamber 2. The EUV collector mirror 23 and the plasma generation region 25 may be located in the high-vacuum chamber 2b.

Upon being introduced with the carrier gas into the low-vacuum chamber 2a, the powder target 27 may travel substantially straight through the low-vacuum chamber 2a with the force of inertia of the powder to pass through the orifice 57. Most of the carrier gas introduced into the low-vacuum chamber 2a may be exhausted by the exhaust device 42a. After passing through the orifice 57, the powder target 27 may travel substantially straight through the high-vacuum chamber 2b with the force of inertia of the powder to reach the plasma generation region 25. According to this configuration, entrance into the high-vacuum chamber 2b of the carrier gas contained in the aerosol can be suppressed, and the plasma generation region 25 and the space therearound can be maintained under high vacuum. The other points may be the same as the first embodiment.

7.9 Variation (3) of Chamber

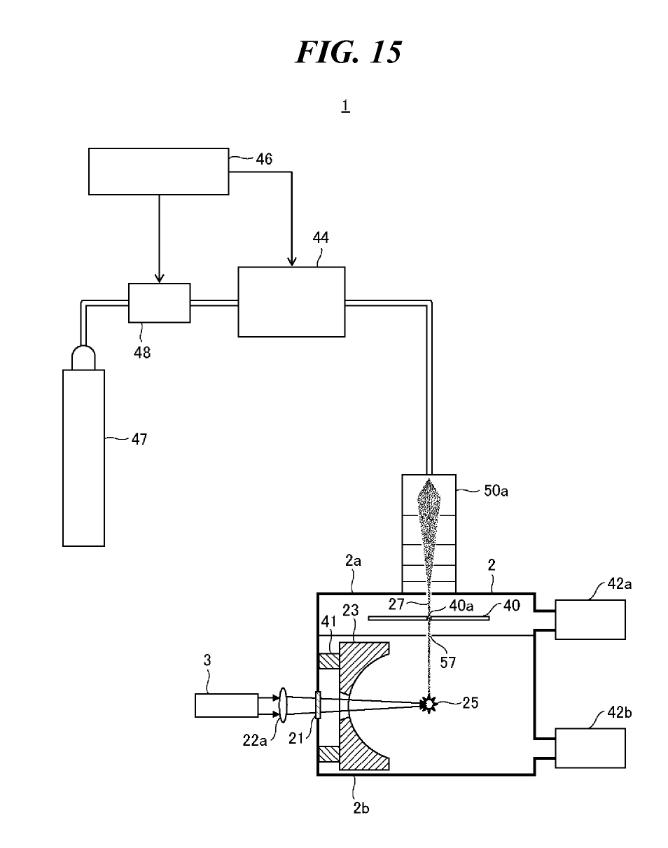

FIG. 15 schematically illustrates an exemplary configuration of the EUV light generation device 1 according to a tenth embodiment. In the tenth embodiment, the chamber 2 may have a beam shaping plate 40 having an aperture 40a formed therein. The beam shaping plate 40 may be held by a holder (not illustrated) in the low-vacuum chamber 2a of the chamber 2. The aperture 40a may be located on the trajectory of the powder target 27. The diameter of the aperture 40a may be smaller than the beam diameter of the powder target 27 having reached the aperture 40a and an area therearound.

According to this configuration, the beam diameter of the powder target 27 can be further adjusted. Further, the shape of a beam cross-section of the powder target 27 can be adjusted by the shape of the aperture 40a. The other points may be the same as the ninth embodiment.

7.10 Variation (1) of Laser Device

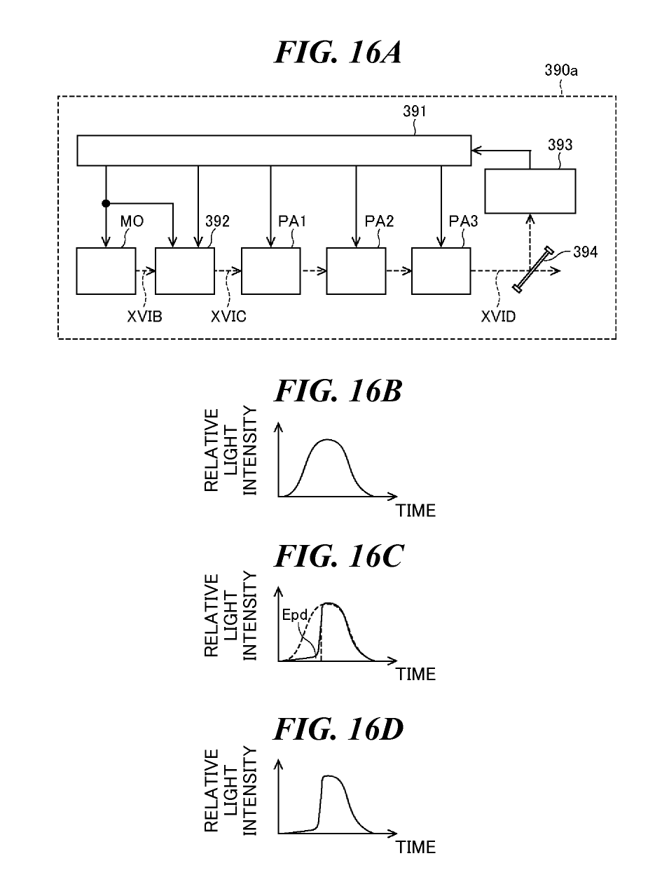

FIG. 16A schematically illustrates an exemplary configuration of the laser device 390a that is used in an eleventh embodiment. The laser device 390a in the eleventh embodiment may include a waveform adjuster 392 between the master oscillator MO and the amplifier PA1. Further, the laser device 390a may include a beam splitter 394 disposed in an optical path of a pulse laser beam that is outputted from the amplifier PA3. Furthermore, the laser device 390a may include a pulse waveform detector 393 disposed in either of two optical paths divided by the beam splitter 394.

FIG. 16B is a graph showing a pulse waveform of the pulse laser beam outputted from the master oscillator MO and indicated by a broken line XVIB in FIG. 16A. FIG. 16C is a graph showing a pulse waveform of the pulse laser beam that is outputted from the waveform adjuster 392 and indicated by a broken line XVIC in FIG. 16A. FIG. 16D is a graph showing a pulse waveform of the pulse laser beam that is outputted from the amplifier PA3 and indicated by a broken line XVID in FIG. 16A. In the following description of the embodiment, a vertical axis of a graph of the pulse waveform of a pulse laser beam represents relative intensity and normalized by a representative peak value of the pulse waveform.

As shown in FIG. 16B, the pulse waveform of a pulse laser beam that is outputted from the master oscillator MO may include: a first stage during which light intensity increases; a second stage during which the light intensity reaches the peak value from the end of the first stage; and a third stage during which the light intensity decreases from the end of the second stage.

The waveform adjuster 392 may adjust the waveform of a pulse laser beam outputted from the master oscillator MO. For example, the waveform adjuster 392 may receive a pulse laser beam having the pulse waveform shown in FIG. 16B and may output a pulse laser beam having a pulse waveform adjusted to be the waveform shown in FIG. 16C. The pulse laser beam having the pulse waveform shown in FIG. 16C may be amplified by the plurality of amplifiers and may be outputted, for example, from the amplifier PA3 as a pulse laser beam having the pulse waveform shown in FIG. 16D. As shown in FIG. 16C, the pulse waveform of the pulse laser beam that is outputted from the waveform adjuster 392 may include: a first stage during which light intensity is low; a second stage during which the light intensity steeply increases from the end of the first stage to reach the peak value; and a third stage during which the light intensity decreases from the end of the second stage. Irradiation of the powder target 27 with the laser beam having such pulse waveform may cause the powder target to be partially gasified by the energy of the laser beam at the first stage to be in a state of mixture of solid fine particles of the target material and a gas of the target material. In such a state of mixture, the target can be efficiently turned into plasma by the energy of the laser beam at the second and third stages, and EUV light can be generated from the plasma. Therefore, the conversion efficiency (CE) from the energy of the pulse laser beam to the energy of the EUV light can be improved.

For further improvement in CE, the pulse waveform of the pulse laser beam that is outputted from the waveform adjuster 392 may have the following feature. Assuming that Epd is an integrated value of light intensities during the first stage, and that Eto is an integrated value of light intensities of the entire pulse waveform throughout the first to third stages, ratio R may be represented by the following equation:

R=Epd/Eto

In this case, R may preferably satisfy 1%≦R≦7.5%, more preferably 2%≦R≦5%. When CE is at its maximum, it may be preferable that R be 3.5%. The control unit 391 may control the waveform adjuster 392 in accordance with the waveform of a laser beam as detected by the pulse waveform detector 393. The other points may be the same as the first embodiment.

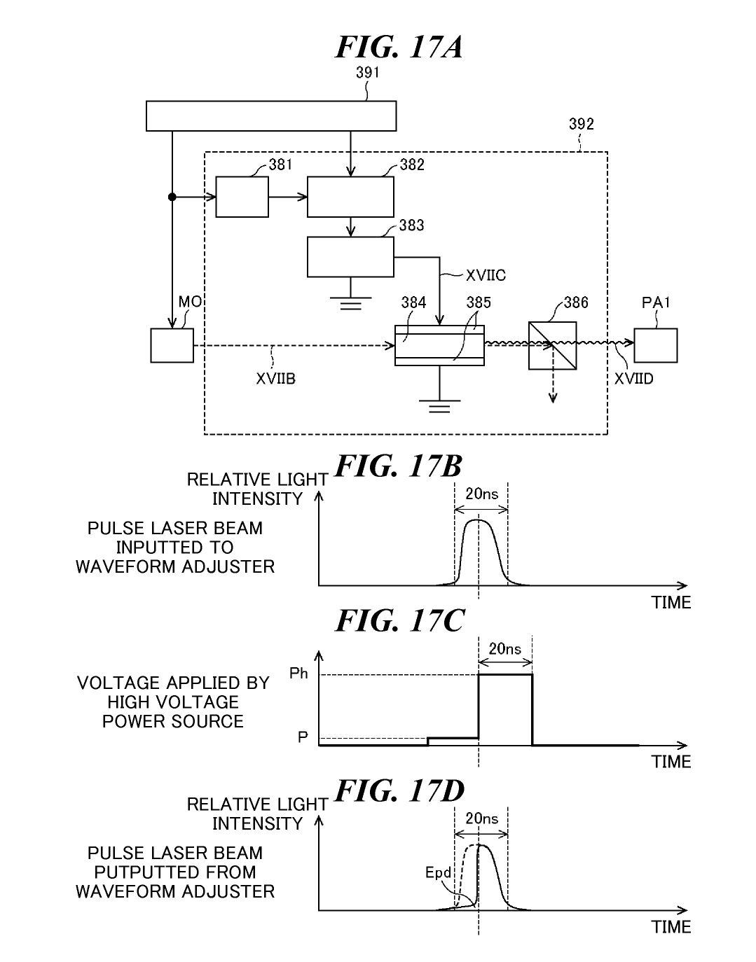

FIG. 17A schematically illustrates an exemplary configuration of the waveform adjuster 392 shown in FIG. 16A. The waveform adjuster 392 may include a delay circuit 381, a voltage waveform generation circuit 382, a high-voltage power source 383, a Pockels cell 384, and a polarizer 386.

The Pockels cell 384 may include a pair of electrodes 385 provided facing each other with an electro-optic crystal positioned therebetween. A pulse laser beam outputted from the master oscillator MO may pass between the pair of electrodes 385. When a voltage is applied between the pair of electrodes 385, the Pockels cell 384 may rotate the plane of polarization of the pulse laser beam by 90 degrees and allow the beam to pass. When a voltage is not applied between the pair of electrodes 385, the Pockels cell 384 may allow the beam to pass without rotating the plane of polarization of the pulse laser beam.

The polarizer 386 may allow a pulse laser beam linearly polarized in a direction parallel to the paper surface to pass through at high transmittance toward the amplifier PA1. The polarizer 386 may reflect a pulse laser beam linearly polarized in a direction perpendicular to the paper surface at high reflectance.

The control unit 391 may output timing signals to both the master oscillator MO and the delay circuit 381. The master oscillator MO may output a pulse laser beam in accordance with the timing signal that is outputted from the control unit 391. The delay circuit 381 may output, to the voltage waveform generation circuit 382, a signal obtained by applying a predetermined delay time to the timing signal that is outputted from the control unit 391. The voltage waveform generation circuit 382 may generate a voltage waveform upon receiving the signal from the delay circuit 381 as a trigger and may supply the voltage waveform to the high-voltage power source 383. The high-voltage power source 383 may generate a pulse voltage based on the voltage waveform and may apply the voltage between the pair of electrodes 385 of the Pockels cell 384.

FIG. 17B is a graph showing a pulse waveform of the pulse laser beam that is outputted from the master oscillator MO and indicated by a broken line XVIIB in FIG. 17A. The pulse laser beam that is outputted from the master oscillator MO may be linearly polarized in a direction perpendicular to the paper surface, and the pulse laser beam may have a pulse width of 20 ns. The pulse waveform of the pulse laser beam may include: a first stage during which light intensity increases; a second stage during which the light intensity reaches the peak value from the end of the first stage; and a third stage during which the light intensity decreases from the end of the second stage.

FIG. 17C is a graph showing a waveform of the pulse voltage that is outputted from the high-voltage power source 383 and propagates through a wire indicated by XVIIC in FIG. 17A. The waveform of the pulse voltage that is outputted from the high-voltage power source 383 may be a waveform having a comparatively low voltage value P in a first half thereof and having a comparatively high voltage value Ph in a second half thereof. The timing of transition from the first half of the voltage waveform to the second half may be synchronized with the timing of the peak of the waveform of the pulse laser beam as shown in FIG. 17B. The first half of the voltage waveform may have duration of about 20 ns, and the second half may also have duration of about 20 ns.

FIG. 17D is a graph showing a pulse waveform of the pulse laser beam that is outputted from the waveform adjuster 392 and indicated by a wavy line XVIID in FIG. 17A. When the voltage shown in FIG. 17C is applied to the Pockels cell 384, a pulse laser beam having a waveform, including a first half portion having a small amount of polarization component parallel to the paper surface and a second half portion having a large amount of polarization component parallel to the paper surface, can pass through the Pockels cell 384. Therefore, in the first half of the pulse waveform of the pulse laser beam, a small portion of the pulse laser beam outputted from the master oscillator MO can pass through the polarizer 386, and in the second half, most of the pulse laser beam outputted from the master oscillator MO can pass through the polarizer 386. This allows the pulse laser beam that is outputted from the waveform adjuster 392 to include: a first stage during which light intensity is low; a second stage during which the light intensity steeply increases from the end of the first stage to reach the peak value; and a third stage during which the light intensity decreases from the end of the second stage. The ratio R of the integrated value Epd of light intensities during the first stage to the integrated value Eto of light intensities of the entire pulse waveform throughout the first to third stages can be adjusted by a voltage waveform as shown in FIG. 17C, that is generated by the high-voltage power source 383. The voltage waveform that is generated by the high-voltage power source 383 may be controlled in accordance with a delay time set by the delay circuit 381 and a voltage value that is outputted by the voltage waveform generation circuit 382.

7.11 Variation (2) of Laser Device

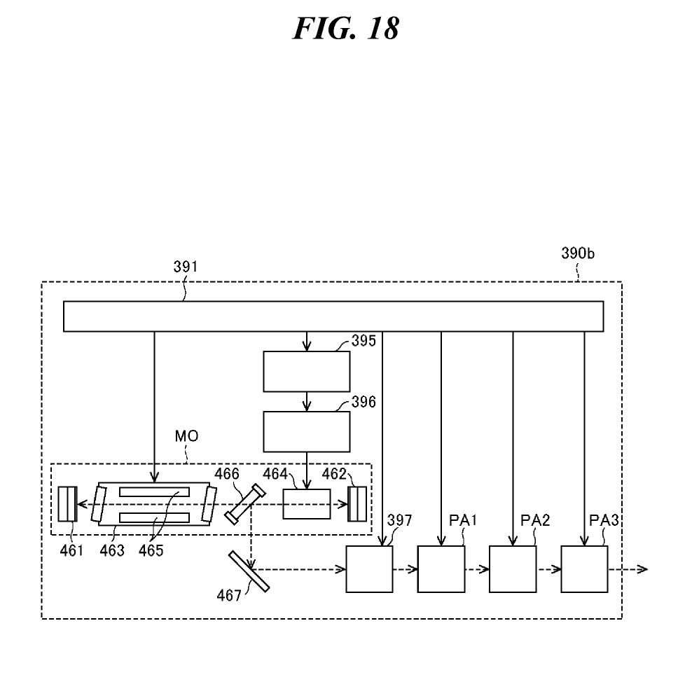

FIG. 18 schematically illustrates an exemplary configuration of a laser device 390b that is used in a twelfth embodiment. The laser device 390b in the twelfth embodiment may include a high-reflecting mirror 467 and a saturable absorber cell 397 between the master oscillator MO and the amplifier PA1. Further, the laser device 390b may include a voltage waveform generation circuit 395 and a high-voltage power source 396.

The master oscillator MO included in the laser device 390b may include an optical resonator having high-reflecting mirrors 461 and 462. Between the high-reflecting mirrors 461 and 462, a laser chamber 463, a polarizer 466 and a Pockels cell 464 may be arranged in this order from the side of the high-reflecting mirror 461. In the laser chamber 463, a pair of electrodes 465 may be disposed and a CO₂ gas may be accommodated as a laser medium.

The master oscillator MO may excite the laser medium inside the laser chamber 463 with discharge that is generated between the pair of electrodes 465, and may cause a laser beam to reciprocate between the high-reflecting mirrors 461 and 462, to thereby amplify the laser beam. The laser beam that reciprocates between the high-reflecting mirrors 461 and 462 may be linearly polarized in a direction parallel to the paper surface. The polarizer 466 may allow a laser beam linearly polarized in a direction parallel to the paper surface to pass through at high transmittance.

The Pockels cell 464 may include an electro-optic crystal (not illustrated) and a pair of electrodes (not illustrated). To the pair of electrodes of the Pockels cell 464, a pulse voltage that is outputted by the high-voltage power source 396 may be applied in accordance with a voltage waveform generated by the voltage waveform generation circuit 395. When the voltage is applied to the pair of electrodes, the Pockels cell 464 may shift the phases of polarized components, orthogonal to each other, of the incident laser beam by a quarter wavelengths and allow the beam to pass. If the laser beam passes through the Pockels cell 464 from the left side to the right side in FIG. 18, then is reflected by the high-reflecting mirror 462, and then passes through the Pockels cell 464 from the right side to the left side in FIG. 18, the phases of orthogonal polarized components may be shifted by a half wavelength in total. Then, the laser beam may enter the polarizer 466 as a laser beam linearly polarized in a direction perpendicular to the paper surface. The polarizer 466 may reflect the laser beam linearly polarized in a direction perpendicular to the paper surface and may output the laser beam from the master oscillator MO.

Here, the waveform of the pulse voltage that is applied to the Pockels cell 464 by the high-voltage power source 396 may have a comparatively low voltage value in a first half thereof and have a comparatively high voltage value in a second half thereof, as shown in FIG. 17C. According to this, a pulse waveform of the pulse laser beam outputted from the Pockels cell 464 may include: a first half portion having a small amount of polarization component perpendicular to the paper surface; and a second half portion having a large amount of polarization component perpendicular to the paper surface. This allows the pulse waveform of the pulse laser beam that is reflected by the polarizer 466 to include: a first stage during which light intensity is low; a second stage during which the light intensity steeply increases from the end of the first stage to reach the peak value; and a third stage during which the light intensity decreases from the end of the second stage. The ratio R of the integrated value Epd of light intensities during the first stage to the integrated value Eto of light intensities of the entire pulse waveform throughout the first to third stages can be adjusted by a voltage waveform which is similar to that shown in FIG. 17C.

The high-reflecting mirror 467 may be disposed in an optical path of the pulse laser beam reflected by the polarizer 466 and may reflect the pulse laser beam at high reflectance toward the saturable absorber cell 397. The saturable absorber cell 397 may, for example, have a gaseous saturable absorber accommodated therein, and the saturable absorber may absorb much of an incident beam having a light intensity of lower than a predetermined value and may transmit much of an incident beam having a light intensity of equal to or higher than the predetermined value. The aforementioned ratio R of the pulse laser beam reflected by the high-reflecting mirror 467 may become smaller by passing through the saturable absorber cell 397. The aforementioned ratio R may become even smaller by heightening the concentration or pressure of the saturable absorber gas inside the saturable absorber cell 397, or lengthening the optical path length of the saturable absorber cell 397. The other points may be the same as the eleventh embodiment described with reference to FIG. 16A.

7.12 Variation (3) of Laser Device

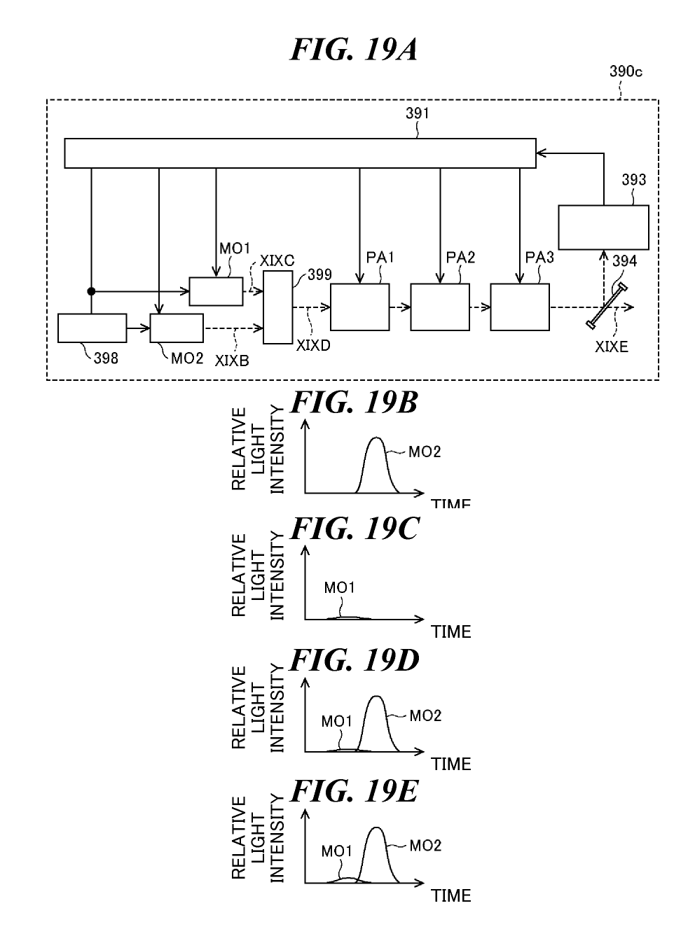

FIG. 19A schematically illustrates an exemplary configuration of a laser device 390c that is used in a thirteenth embodiment. The laser device 390c in the thirteenth embodiment may include a first master oscillator MO1 and a second master oscillator MO2. The laser device 390c may further include a delay circuit 398 and an optical path adjuster 399. The other points may be the same as the eleventh embodiment described using FIG. 16A.

The first master oscillator MO1 may output a first pulse laser beam in synchronization with a timing signal from the control unit 391. The delay circuit 398 may output a signal obtained by applying a predetermined delay time to the timing signal from the control unit 391. The second master oscillator MO2 may output a second pulse laser beam in synchronization with the signal outputted from the delay circuit 398. The optical path adjuster 399 may cause the pulse laser beams outputted respectively from the first and second master oscillators MO1 and MO2 to converge into an optical path toward the amplifier PA1. The optical path adjuster 399 may be constituted by a half mirror or a grating.

FIG. 19B is a graph showing a pulse waveform of the pulse laser beam that is outputted from the second master oscillator MO2 and indicated by a broken line XIXB in FIG. 19A. FIG. 19C is a graph showing a pulse waveform of the pulse laser beam outputted from the first master oscillator MO1 and indicated by a broken line XIXC in FIG. 19A. For illustrative purposes, values in the vertical axis of the graph in FIG. 19C are normalized by the peak value of the pulse laser beam shown in FIG. 19B. The pulse laser beam that is outputted from the first master oscillator MO1 may have smaller peak intensity than the pulse laser beam that is outputted from the second master oscillator MO2. The pulse laser beam that is outputted from the second master oscillator MO2 may have a certain delay time with respect to the pulse laser beam that is outputted from the first master oscillator MO1.

FIG. 19D is a graph showing a pulse waveform of the pulse laser beam outputted from the optical path adjuster 399 and indicated by a broken line XIXD in FIG. 19A. FIG. 19E is a graph showing a pulse waveform of the pulse laser beam that is outputted from the laser device 390c and indicated by a broken line XIXE in FIG. 19A. A pulse laser beam having pulse waveforms such as those shown in these drawings can be outputted by causing the pulse laser beams outputted respectively from the first and second master oscillators MO1 and MO2 to converge into an optical path. These pulse waveforms can each include: a first stage during which light intensity is low; a second stage during which the light intensity steeply increases from the end of the first stage to reach the peak value; and a third stage during which the light intensity decreases from the end of the second stage. The ratio R of the integrated value Epd of light intensities during the first stage to the integrated value Eto of light intensities of the entire pulse waveform throughout the first to third stages can be adjusted by the intensities of the pulse laser beams outputted respectively from the first and second master oscillators MO1 and MO2.

7.13 Variation (4) of Laser Device

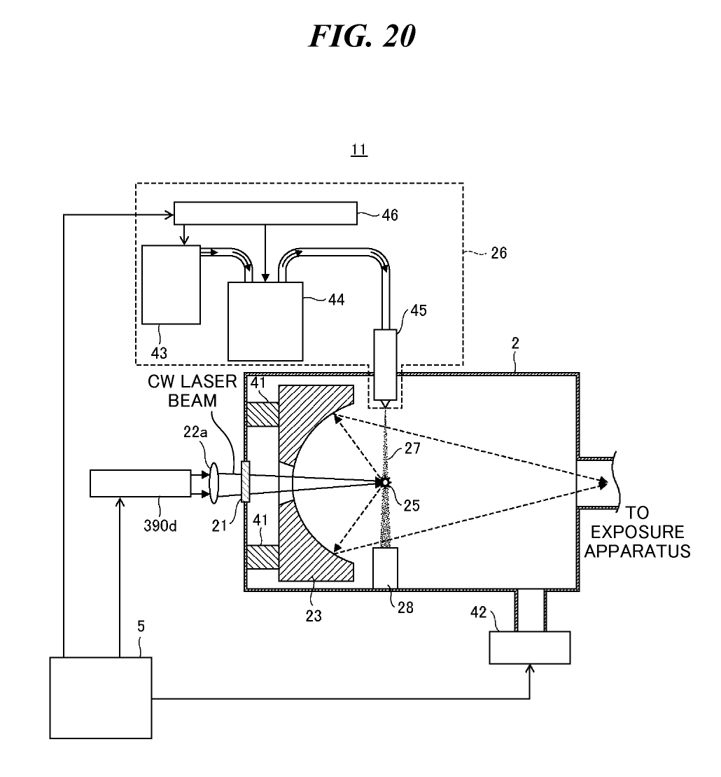

FIG. 20 is a partial cross-sectional view schematically illustrating the EUV light generation system 11 according to a fourteenth embodiment. In the aforementioned embodiments, a case has been described where the laser device 3 generates a pulse laser beam by pulse oscillation. However, the present disclosure is not limited thereto. In the fourteenth embodiment, a laser device 390d may generate a continuous-wave (CW) laser beam by continuous oscillation.

According to this configuration, EUV light can be continuously generated by irradiating the powder target with a continuous-wave laser beam in a case where the powder target is continuously supplied into the chamber. Further, in the case where the powder target is continuously supplied into the chamber, the amount of a target material that is wasted without being irradiated with a laser beam can be reduced.

Assuming that the intensity of a laser beam with which a target material is to be irradiated for EUV light to be sufficiently generated is 1×10¹⁰ W/cm², the laser beam of 70 kW needs only be focused onto a spot approximately 0.03 mm in diameter, for example. In that case, it may be preferable that the beam diameter of the powder target be approximately 0.03 mm. In order to generate a powder target having such a beam diameter, a beam shaping plate 40 having an aperture 40a formed therein, which was described with reference to FIG. 13, may, for example, be used.

The above-described embodiments and the modifications thereof are merely examples for implementing the present disclosure, and the present disclosure is not limited thereto. Making various modifications according to the specifications or the like is within the scope of the present disclosure, and other various embodiments are possible within the scope of the present disclosure. For example, the modifications illustrated for particular ones of the embodiments can be applied to other embodiments as well (including the other embodiments described herein).

The terms used in this specification and the appended claims should be interpreted as “non-limiting.” For example, the terms “include” and “be included” should be interpreted as “including the stated elements but not limited to the stated elements.” The term “have” should be interpreted as “having the stated elements but not limited to the stated elements.” Further, the modifier “one (a/an)” should be interpreted as “at least one” or “one or more.”

1. An extreme ultraviolet light generation device configured to generate extreme ultraviolet light by irradiating a target with a laser beam to turn the target into plasma, comprising:
a chamber provided with at least one through-hole;
an optical system configured to introduce the laser beam into a predetermined region in the chamber through the at least one through-hole; and
a target supply device configured to supply a powder target as the target to the predetermined region.

2. The extreme ultraviolet light generation device according to claim 1, wherein the target supply device includes:
a carrier gas supplier configured to supply a carrier gas; and
an aerosol generator configured to generate an aerosol by dispersing the powder target in the carrier gas supplied by the carrier gas supplier, and
wherein the target supply device is configured to supply, to the predetermined region, the powder target contained in the aerosol generated by the aerosol generator.

3. The extreme ultraviolet light generation device according to claim 2, wherein the target supply device further includes a mechanism that suppresses the powder target contained in the aerosol generated by the aerosol generator from being diffused within the chamber.

4. The extreme ultraviolet light generation device according to claim 2, wherein the target supply device further includes an aerodynamic lens having a multistage orifice in a flow channel of the aerosol between the aerosol generator and the predetermined region.

5. The extreme ultraviolet light generation device according to claim 2, wherein:
the carrier gas supplier is configured to supply a carrier gas containing a hydrogen gas to the aerosol generator; and
the aerosol generator is configured to generate the aerosol by dispersing the powder target containing tin in the carrier gas supplied by the carrier gas supplier.

6. An extreme ultraviolet light generation system configured to generate extreme ultraviolet light by irradiating a target with a laser beam to turn the target into plasma, comprising:
a laser device configured to output the laser beam;
a chamber provided with at least one through-hole;
an optical system configured to introduce the laser beam into a predetermined region in the chamber through the at least one through-hole; and
a target supply device configured to supply a powder target as the target to the predetermined region.

7. The extreme ultraviolet light generation system according to claim 6, wherein the laser device is configured to output a pulse laser beam as the laser beam by pulse oscillation.

8. The extreme ultraviolet light generation system according to claim 7, wherein the laser device is configured to output the pulse laser beam whose pulse waveform includes: a first stage during which light intensity is low; a second stage during which the light intensity steeply increases from an end of the first stage to reach a peak value; and a third stage during which the light intensity decreases from an end of the second stage.

9. The extreme ultraviolet light generation system according to claim 6, wherein the laser device is configured to output a continuous-wave laser beam as the laser beam by continuous oscillation.
